(19) United States
(12) Patent Application Publication
(10) Pub. No.: US 2026/0257831 A1
(43) Pub. Date: Sep. 3, 2026

(54) PACKAGING CONTAINER MADE OF BIODEGRADABLE FIBER MATERIAL

(71) Applicant: PAPACKS SALES GMBH, KOELN (DE)

(72) Inventors: Tahsin Dag, Koeln (DE); Manuel Leibrock, Koeln (DE); Memet Dag, Arnstadt (DE)

(73) Assignee: PAPACKS SALES GMBH, KOELN (DE)

(21) Appl. No.: 19/536,867

(22) Filed: Feb. 11, 2026

(30) Foreign Application Priority Data
Feb. 28, 2025 (DE) 102025107709.6
Aug. 28, 2025 (DE) 102025134567.8

(51) Int. Cl. B65D 5/00; B65D 1/02; B65D 21/02; B65D 43/16; B65D 85/34

(52) U.S. Cl. CPC B65D 5/0015; B65D 1/0207; B65D 21/0233; B65D 43/16; B65D 43/169; B65D 85/34; B65D 2543/00296; B65D 2543/00527; B65D 2543/00685; B65D 2543/00796

(57) ABSTRACT

A packaging container made of biodegradable fiber material, comprising a shell-shaped base body with a bottom wall, a surrounding side wall and a peripheral rim, and a lid with a lid wall and a lid rim that extends complementary to the peripheral rim, wherein the base body and the lid are produced from a pulp containing a mixture of water and fresh fiber by means of a mold, wherein alkyl ketene dimers are added to the pulp as an additive, wherein the base body and the lid are dried and pressed after drying, and wherein the base body and the lid have a wall thickness of at least 3 mm. The fiber material packaging designed in this way is suitable for storing chilled food and provides both a strong insulating effect to prevent chilled food from warming up, as well as good resistance to moisture.

### CROSS REFERENCES TO RELATED APPLICATIONS

This application claims priority to and the benefit of German Application No. 10 2025 107 709.6, filed Feb. 28, 2025, and to German Application No. 10 2025 134 567.8, filed Aug. 28, 2025, both of which are incorporated herein by reference in their entirety.

### BACKGROUND OF THE INVENTION

### 1. Field of the Invention

The present invention relates to packaging containers made of biodegradable fiber material.

### 2. Description of the Prior Art

It is generally known in the prior art to provide products made of molded fiber material.

Prior art patent documents include the following:

German Patent Publication No. 102020121977 for Process and device for the production of a fiber shaped body by inventors Dag, et al., filed Aug. 21, 2020 and published Feb. 24, 2022, is directed to a method and a device for producing a fibrous molded body, in which a fibrous molded body is formed by sucking fibrous material from a pulp through a suction mold and compressing the fibrous material on the suction mold. The invention is based on the object of providing a method and a device which enables the production of fiber shaped bodies with a smooth surface and high dimensional stability with a shortened process time and reduced energy input. To solve this task, the following steps are suggested: a) transfer of the fiber shaped body to a dewatering mold, b) pressing a counter-mold onto the molded fiber body arranged on the dewatering mold, the molded fiber body being dewatered by the counter-mold being pressed, c) drying of the fiber shaped body.

U.S. Pat. No. 11,306,440 for Methods and apparatus for manufacturing fiber-based meat containers by inventors Chung, et al., filed Jun. 28, 2019, and issued Apr. 19, 2022, is directed to methods and apparatus for vacuum forming a meat tray using a slurry. The slurry comprises: a moisture barrier comprising AKD in the range of about 4% by weight; a fiber base comprising bagasse; and an oil barrier comprising a water-based emulsion in the range of about 1.5% by weight.

### SUMMARY OF THE INVENTION

The present invention relates to packaging containers made of biodegradable fiber material. In particular, the present invention relates to a packaging container with a wall made of biodegradable fiber material, in particular cellulose fibers. The fiber material is drawn into shape using a mold, e.g., a suction mold, from fiber pulp. The packaging container has a shell-shaped base body with a bottom wall, a surrounding side wall, and a peripheral rim. The packaging container also has a lid with a top wall and a surrounding lid rim. The surrounding lid rim is designed to complement the peripheral rim of the shell-shaped base body and engages this peripheral rim. For example, the packaging containers can be used to replace expanded polystyrene (EPS) trays or EPS boxes. Insulating EPS boxes generally have wall thicknesses of 20 to 30 mm and even 50 mm and more. Compared to EPS boxes, the insulating packaging containers made of biodegradable fiber material of the present invention have a wall thickness of more than 3 mm and up to 5 mm or 6 mm.

It is an object of this invention to provide fiber packaging containers in such a way that it is suitable for storing refrigerated food and that it has both a strong insulating effect to prevent refrigerated food from warming up and good resistance to moisture. In particular, it should be possible to use this fiber packaging container to package ice for cooling together with food products for several days without the packaging container becoming excessively damp and without the ice melting prematurely.

In one embodiment, the present invention includes a packaging container made of biodegradable fiber material, including a shell-shaped base body with a bottom wall, a surrounding side wall, and a peripheral rim, a lid with a top wall and a lid rim that extends complementary to the peripheral rim of the shell-shaped base body, wherein the base body and the lid are produced by means of a mold from a pulp containing a mixture of water and fresh fiber, wherein alkyl ketene dimers are added to the pulp as an additive, wherein the base body and the lid are dried and pressed after drying, and wherein the base body and the lid have a wall thickness of at least 3 mm. It is to be noted that the specific geometric configurations, the nesting properties of the containers described herein and the specific configuration of the rim of the container and of the lid do not necessarily depend on the wall thickness and are of technical benefit for packaging containers with wall thicknesses outside the range mentioned above. In case of reduced stability or insulation requirements, the wall thickness can amount to less than 3 mm or more than 6 mm. In one embodiment, a range of wall thicknesses stretches, for example, from 2.5 mm to 8 mm. The geometric configurations described herein are useful for all practical values of wall thickness. The same applies to the additive to the pulp. While using a pulp containing a mixture of water and fresh fiber, wherein alkyl ketene dimers are added to the pulp as an additive, is useful for producing a water resistant and strongly insulating packaging for food, other fiber material with or without additives may be used for other purposes such as non-food packaging or packaging for dry products.

In another embodiment, the present invention includes a method for producing a packaging container from biodegradable fiber material, including preparing a pulp from water and fresh fibers, adding alkyl ketene dimers as an additive to the pulp, suctioning the fibers from the pulp with a first mold to form a first fiber molded body for a shell-shaped base body and with a second mold to form a second fiber molded body for a lid, transferring the first fiber molded body and the second fiber molded body to a drying device and drying the first fiber molded body and the second fiber molded body, and pressing the first fiber molded body and second fiber molded body, wherein the first fiber molded body and second fiber molded body have a wall thickness of at least 3 mm after pressing.

In yet another embodiment, the present invention includes a packaging container made of biodegradable fiber material, including, a shell-shaped base body with a bottom wall, a surrounding side wall, and a peripheral rim, and a lid with a top wall and a lid rim that extends complementary to the peripheral rim of the shell-shaped base body, wherein the biodegradable fiber material contains hemp fibers.

In yet another embodiment, the present invention includes a packaging container made of biodegradable fiber material, including a shell-shaped base body with a bottom wall, a surrounding side wall, and a peripheral rim, and a lid with a top wall and a lid rim that extends complementary to the peripheral rim of the shell-shaped base body, wherein the peripheral rim has a portion that extends downward beyond the lid rim.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a schematic flow chart of a method for manufacturing a packaging container.

FIG. 2 illustrates a perspective view of two different sizes of the base body of the packaging container according to one embodiment.

FIG. 3 illustrates a perspective view of stacked packaging containers with base bodies and matching lids, according to one embodiment.

FIG. 4 illustrates an additional perspective view of a packaging container, according to one embodiment.

FIG. 5 illustrates the packaging container of FIG. 4 on a reduced scale with the lid raised.

### DETAILED DESCRIPTION

The present invention is generally directed to packaging containers made of biodegradable fiber material, and more specifically to fiber-based packaging containers suitable for storing refrigerated food with resistance to moisture. These packaging containers may be intended to replace EPS boxes with wall thicknesses of more than 20 mm. Compared to EPS boxes the packaging containers described herein are relatively thin-walled.

In one embodiment, the present invention includes a packaging container made of biodegradable fiber material, including a shell-shaped base body with a bottom wall, a surrounding side wall, and a peripheral rim, a lid with a top wall and a lid rim that extends complementary to the peripheral rim of the shell-shaped base body, wherein the base body and the lid are produced by means of a mold from a pulp containing a mixture of water and fresh fiber, wherein alkyl ketene dimers are added to the pulp as an additive, wherein the base body and the lid are dried and pressed after drying, wherein the base body and the lid have a wall thickness of at least 3 mm, wherein the peripheral rim has a portion extending outward parallel to the bottom wall and an adjoining portion extending downward toward the bottom wall, wherein the lid rim has an outwardly extending portion and an adjoining portion extending downward toward the bottom wall, wherein the top wall of the lid is connected to the outwardly extending portion of the lid rim via an upwardly extending junction section, wherein the adjoining portion of the lid rim extending downward toward the bottom wall ends above the adjoining portion of the peripheral rim extending downward toward the bottom wall, wherein the adjoining portion of the lid rim extending downwards toward the bottom wall has at least one recess, wherein the surrounding side wall of the shell-shaped base body includes several rib-like bulges, wherein the rib-like bulges extend transverse to the surrounding side wall of the base body, wherein the extension of the rib-like bulges is equal to or less than five times the surrounding wall thickness, wherein the lid includes four corners, wherein each corner of the four corners includes a recess, wherein each recess includes a retaining projection which protrudes from one side of the recess towards a center of the recess, and further comprising a biodegradable or bioinert coating applied to an inside of the shell-shaped base body and/or to a side of the lid facing the base body.

In another embodiment, the present invention includes a method for producing a packaging container from biodegradable fiber material, including preparing a pulp from water and fresh fibers, adding alkyl ketene dimers as an additive to the pulp, suctioning the fibers from the pulp with a first mold to form a first fiber molded body for a shell-shaped base body and with a second mold to form a second fiber molded body for a lid, transferring the first fiber molded body and the second fiber molded body to a drying device and drying the first fiber molded body and the second fiber molded body, and pressing the first fiber molded body and second fiber molded body, wherein the first fiber molded body and second fiber molded body have a wall thickness of at least 3 mm after pressing, wherein the pulp includes between 32 kg- 48 kg of fresh fibers, between 1.0 liters- 1.4 liters of alkyl ketene dimers, and 1000 liters of water, further comprising placing the first fiber molded body and the second fiber molded body on a conveyor belt of the drying device, transporting via the conveyor belt, the first fiber molded body and the second fiber molded body through a drying tunnel of the drying device, drying the first fiber molded body and the second fiber molded body to a residual moisture content in the range of 15% to 25%, and pressing the first fiber molded body and second fiber molded body with a pressing force of 50 t to 70 t and at a temperature of 130° C. to 150° C., and further comprising spraying a biodegradable or bioinert coating onto an inside of the shell-shaped base body and/or or onto a side of the lid facing the base body.

In yet another embodiment, the present invention includes a packaging container made of biodegradable fiber material, including, a shell-shaped base body with a bottom wall, a surrounding side wall, and a peripheral rim, and a lid with a top wall and a lid rim that extends complementary to the peripheral rim of the shell-shaped base body, wherein the biodegradable fiber material contains hemp fibers, wherein the fiber material contains a mixture of hemp fibers and ground hemp shives, wherein the surrounding side wall of the shell-shaped base body includes several rib-like bulges, wherein the lid includes four corners, wherein each corner of the four corners includes a recess, wherein each recess includes a retaining projection which protrudes from one side of the recess towards a center of the recess, and further comprising a biodegradable or bioinert coating applied to an inside of the shell-shaped base body and/or to a side of the lid facing the shell-shaped base body.

In yet another embodiment, the present invention includes a packaging container made of biodegradable fiber material, including a shell-shaped base body with a bottom wall, a surrounding side wall, and a peripheral rim, and a lid with a top wall and a lid rim that extends complementary to the peripheral rim of the shell-shaped base body, wherein the peripheral rim has a portion that extends downward beyond the lid rim, wherein the base body and the lid have a wall thickness of at least 3 mm, wherein the surrounding side wall of the shell-shaped base body includes several rib-like bulges, wherein the lid includes four corners, wherein each corner of the four corners includes a recess, wherein each recess includes a retaining projection which protrudes from one side of the recess towards a center of the recess, and further comprising a biodegradable or bioinert coating applied to an inside of the shell-shaped base body and/or to a side of the lid facing the base body.

Packaging structures, such as containers, made of cardboard-like fiber material, consisting of two parts, namely a base body and a lid, is known, for example, for packaging eggs as egg cartons. Here, the two parts of the packaging, namely the base body and the lid, are connected to each other by webs. They are usually manufactured using suction molds, which draw the fiber layer forming the base body and the lid simultaneously. However, the packaging is also used to hold other foods, such as hamburgers. German publication DE 102020121977 describes a method for manufacturing a fiber molded body using a pulp molding process, which is incorporated herein by reference in its entirety. In this process, a suction mold is immersed in a pulp, also known as a fiber slurry or fiber dispersion. The pulp contains water and fibers, which are drawn by the suction mold. A vacuum is applied to the suction mold, which is conducted to the porous surface through pressure channels in the suction mold. The water in the pulp flows out through pores or openings in the surface of the suction mold that are smaller than the fibers, while the fiber content is concentrated on one surface of the suction mold. The fiber content, also known as the dry matter content, is increased on the surface of the suction mold, so that the fiber molded body is formed there. After the fiber molded body has been demolded, the dry matter content is further increased by subsequent drying, which solidifies the fiber molded body. The fiber molded body is transferred from the suction mold to a dewatering mold, where it is wet pressed before being transported onward for drying.

U.S. Pat. No. 11,306,440 describes a packaging of fiber material that is particularly suitable for storing meat and poultry. To achieve a moisture or water barrier, alkyl ketene dimers (AKD) are added to the fiber pulp as an additive.

It is an object of this invention to provide fiber packaging containers in such a way that it is suitable for storing refrigerated food and that it has both a strong insulating effect to prevent refrigerated food from warming up and good resistance to moisture. In particular, it should be possible to use this fiber packaging container to package ice for cooling together with food products for several days without the packaging container becoming excessively damp and without the ice melting prematurely.

Referring now to the drawings in general, the illustrations are for the purpose of describing one or more preferred embodiments of the invention and are not intended to limit the invention thereto.

The present invention provides fiber packaging which includes a base body and a lid, wherein both the base body and the lid are manufactured using a mold from a pulp containing a mixture of water and fresh fiber, to which alkyl ketene dimers are added as an additive; wherein the base body and the lid are dried and pressed after drying; wherein after pressing, the base body and the lid have a wall thickness of at least 3 mm.

Both the base body and the lid are made of fiber material which distinguishes the packaging container from known packaging containers, in which only the base body is made of fiber material and the lid is made of plastic film. Additionally, this is distinguishing from known EPS containers (also known as Styrofoam). The packaging container of the present invention avoids any plastic waste. Alkyl ketene dimers (AKD) are added to the pulp to improve its resistance to moisture and water. In particular, the base body and lid are dried and only pressed after drying is complete, for example after reaching a residual moisture content of 20%. Drying takes place in a drying device, preferably in a drying tunnel. A drying tunnel is usually several meters long, enclosed by a housing, has a heating device and is traversed by a conveyor belt. Because the drawn fiber layer is deformed and dried and only then pressed, it is possible to achieve large wall thicknesses of 3 mm and above. In contrast, the shell of U.S. Pat. No. 11,306,440 is wet-pressed and only achieves wall thicknesses of 0.3 to 1.5 mm. Suction through the suction mold takes place over an extended period of time so that the required amount of fiber per unit area is deposited on the surface of the suction mold. The large wall thickness of 3 mm and more proposed herein results in greater thermal insulation than known fiber packaging and greater resistance to moisture. However, fiber molded bodies with a large amount of fiber per unit area are very heavy and unstable. For this reason, the drawn fibers are first dried to a great extent before being pressed. Fresh fibers that are approved for food packaging are used in the manufacturing process. AKD glue is also safe for food packaging. The features of the present invention result in fully biodegradable packaging for food that requires refrigeration, which provides excellent thermal insulation and is also suitable for storing moist food.

Alternatively, the fiber molded body can be produced from fiber pulp using two complementary press molds. The two press molds are pressed together, leaving a gap between the porous walls of the press molds, wherein the fiber material is compressed in the gap. The water in the fiber pulp escapes through the porous walls of the press molds.

Compared to the previous EPS boxes, the use of packaging made of cellulose fiber material has the advantage that no plastic waste is produced that needs to be recycled. The packaging made of biodegradable cellulose fibers can simply be disposed of in the recycling if it is not contaminated. In addition, the packaging of the present invention has advantageous breakage behavior compared to EPS boxes. If an EPS box made of expanded polystyrene is subject to an impact or a fall, it breaks and small plastic pellets often form at the breaking points. These small plastic particles are very problematic in hygienic environments, such as food processing. Fiber-based packaging does not break or disintegrate into small particles, so there is no risk of contamination in hygienic environments.

Cellulose fibers are commonly used as the fiber material for manufacturing molded fiber bodies from fiber pulp, for example, fresh fibers from paper material consisting of wood fibers. In practice, however, the fiber material may also contain hemp fibers or consist of hemp fibers. The use of industrial hemp for the production of packaging has the great advantage that no forests need to be cleared for its production; instead, plants cultivated for this application are used for fiber production. Hemp fibers result in high stability of the packaging wall and increase the thermal insulation effect of the wall consisting of fiber material. In particular, a mixture consisting of crushed hemp fibers and ground hemp shives has proven itself in the production of fiber molded bodies. U.S. Pat. No. 12,246,897, U.S. Pat. No. 12,338,048, and US Patent Publication No. 2026/0015144 describe biodegradable pulp packaging products made from natural fibers including micronized hemp fibers and pulverized hemp shive, each of which is incorporated herein by reference in its entirety.

In one embodiment, the packaging container includes a shell-shaped base body, which includes a peripheral rim. In one embodiment, the peripheral rim of the shell-shaped base body may have a portion extending outwardly parallel to the bottom wall and an adjoining portion extending downwards toward the bottom wall. In other words, the wall of the shell-shaped base body initially runs straight or diagonally upwards from the bottom wall, then runs parallel to the bottom wall at the upper peripheral rim and finally runs downwards again towards the bottom. The peripheral rim of the shell-shaped base body thus has the shape of an inverted U in cross-section, which increases stability of the overall base body. The lid may have a complementary lid rim with an outwardly extending portion and an adjoining portion extending toward the bottom wall. The fact that the lid rim runs over the entire periphery at a small distance complementary to the peripheral rim of the shell-shaped base body and fits closely against the peripheral rim increases the tightness between the shell-shaped base body and the lid. The top wall of the lid may also be connected to the outwardly extending rim portion via an upwardly extending junction section. The top wall of the lid is thus lowered relative to the outer rim portion of the lid. The top of the lid consequently forms a trough-like recess, which can essentially correspond to the shape of the lower section of the shell-shaped base body. In this way, the shell-shaped base body can be stacked on the top wall of the lid of a packaging container located below without risking that the upper shell-shaped base body slips relative to the lower shell-shaped base body. The packaging containers can therefore be stacked securely.

It is also possible to produce a set of packaging containers of different sizes, in which, for example, the shell-shaped base bodies of a small packaging size are shaped in such a way that they can stand side by side on the top wall of a lid of a large packaging size. In this way, packaging containers of different sizes can be stacked securely and stably.

In one embodiment, the downward-sloping portion of the peripheral rim of the shell-shaped base body may have at least one recess. If the lid rim is smooth, an engagement opening is created in the area of the recesses between the otherwise parallel lid rim and peripheral rim, so that the lid rim can be gripped from behind with a finger by a user in order to allow air to enter the packaging and open the lid.

In one embodiment, the surrounding wall of the shell-shaped base body may have several rib-like bulges. This increases the stability of the shell-shaped base body. The rib-like bulges may extend in the longitudinal and transverse directions of the shell-shaped base body. The extension of the rib-like bulge transverse to the main plane of the wall of the base body can be equal to or less than five times the wall thickness. A depth of the rib-like bulge transverse to the wall extension of about 2 cm or less has proven effective in stabilizing the wall. The packaging container with the rib-like bulges may carry a load in excess of 100 kg for several days and is, therefore, perfectly suited for containing cooled food products during transport, in particular fish, seafood, meat and vegetables. At the same time, the relatively flat extension prevents the bulges from transferring their shape to the food contained in the packaging. Such deformation of the food, for example of fish contained in the packaging, can negatively affect the visual appearance and thus the value of the food. The flat ribs prevent deformation. In addition, the flat rib-like bulges allow for affixing a label to the side wall of the base body for labeling the packaging. Furthermore, the fairly flat bulges result in a large volume of the interior of the packaging and in the bottom wall of the packaging having a fairly large footprint. Ribs in the bottom wall cause the items placed in the packaging to be at a certain distance from the bottom wall. In particular, if an absorbent mat, preferably made of biodegradable material, is placed on the ribs in the bottom wall, water can collect between the ribs and the products lying on the absorbent mat, especially food, remains largely dry.

In one embodiment, the lid may have a recess in each corner. In one embodiment, the lid includes four corners. The recesses in the corners of the lid significantly stiffen the lid. In addition, the lid can be stacked more easily after manufacturing due to the recesses in the corners engaging one another. In another embodiment, each recess may have a retaining projection extending from one side of the recess to the center of the recess. The retaining projection prevents the recesses of two stacked lids from protruding too deeply into each other. When two lids are stacked, the undersides of the recesses of the upper lid rest on the retaining projections in the recesses of the lower lid. The upper lid can be easily lifted off the lower lid.

In one embodiment, a biodegradable coating can be sprayed onto the packaging container. In particular, the inside of the shell-shaped base body and the side of the lid facing the base body can be coated with a biodegradable coating. However, a bioinert coating, for example based on silicon, can also be used. Although this does not biodegrade quickly, it is not harmful to the environment when disposed of in a landfill. The coated surfaces face the moist contents of the packaging and can be made more resistant to moisture penetration by means of a moisture-repellent coating. A silicon-based coating gives the surface a special glass-like hardness.

In one embodiment, the present invention provides a method for producing a packaging container from biodegradable fiber material. The biodegradable fiber material packaging described herein can be produced in practice using the following method: preparing a pulp from water and fresh fibers, to which alkyl ketene dimers are added as an additive; suctioning of the fibers from the pulp with a first suction mold to form a first fiber molded body for a shell-shaped base body and with a second suction mold to form a second fiber molded body for a lid; transferring the first fiber molded body and the second fiber molded body to a drying device and drying of the fiber molded bodies; pressing the first fiber molded body and the second fiber molded body, wherein the first fiber molded body and second fiber molded body have a wall thickness of at least 3 mm after pressing.

In one embodiment, the first suction mold and the second suction mold can be two partial molds of a multiple suction mold, with which both the shell-shaped base body and the lid can be produced simultaneously. Depending on the size of the packaging to be produced, the multiple suction mold can also have several suction areas for producing several shell-shaped base bodies and/or lids.

In one embodiment, 40 kg of fresh fiber and 1.2 liters of alkyl ketene dimers (AKD) can be mixed with 1000 liters of water for the preparation of the pulp. In one embodiment, 32 kg- 48 kg of fresh fiber, between 1.0 liters- 1.4 liters of AKD, and 1000 liters of water can be mixed for the preparation of the pulp. This forms a fiber layer with optimal thermal insulation properties and the desired resistance to moisture. The fiber content in the pulp can vary by 20% up or down. Similarly, the AKD content can vary by approximately 0.2 liters up or down, while still producing packaging of the desired quality.

In one embodiment, the molded bodies for forming the shell-shaped base bodies and/or lids can be dried to a residual moisture content in the range of 15 to 25%, preferably 20%, before being pressed. Pressing the molded bodies, which are already largely dried, results in very good dimensional stability of the pressed molded bodies, i.e., the surface of the pressed molded bodies exactly follows the surface of the pressing tools. Using the method described (first drying, then pressing), can achieve the desired large wall thickness of over 3 mm and up to 5 or 6 mm.

In one embodiment, the fiber molded bodies are pressed with a pressing force of 50 to 70 t, preferably 60 t, and/or at a temperature of 130 to 150° C., preferably 140° C. The high pressing force of around 60 t also contributes to the dimensional stability of the pressed molded bodies. The increased temperature of the pressing tool means that the fiber material of the molded bodies precisely follows the shape of the pressing tool, whereby during pressing the fiber material of the molded body is pressed into a cavity between the two complementary parts of the pressing tool that corresponds to the wall of the finished molded body. In addition, the high temperature of the pressing tool dries the molded body during the pressing process and preserves the shape imparted by the pressing tool after the pressing process.

After pressing, at least one side of the base body and one side of the lid can be coated with a biodegradable or bioinert coating, as described above.

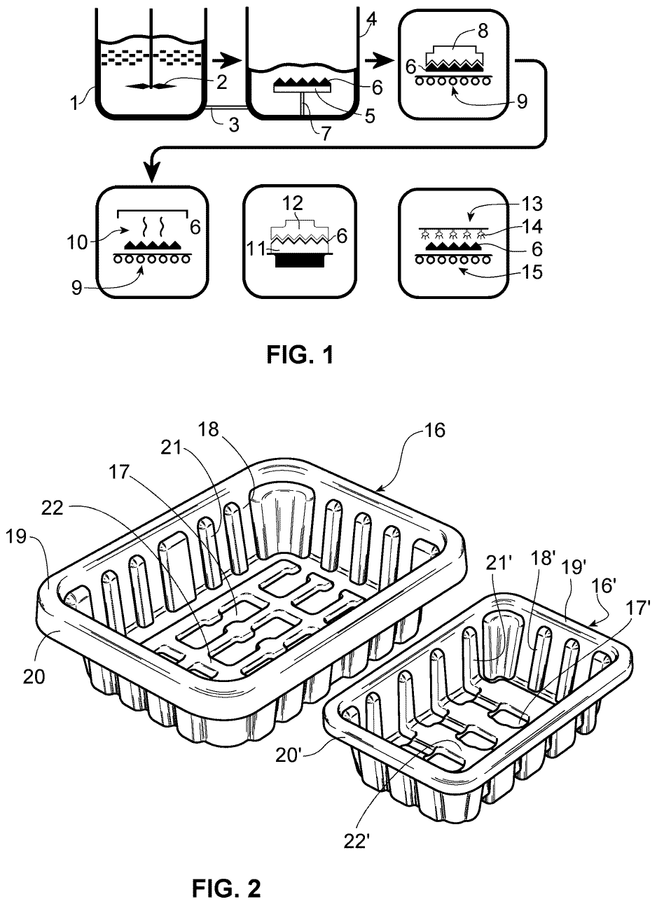

FIG. 1 illustrates the steps of the method described herein for producing a packaging container from biodegradable fiber material. First, water is mixed with pulp for the preparation of a pulp suitable for the production of fiber molded bodies using the fiber casting process in a stirring tank 1 with a stirrer 2. To produce the pulp, 1000 liters of water, between 32 and 48 kg of fresh fiber, and between 1.0 and 1.4 liters of alkyl ketene dimers (AKD) are added to the stirring tank 1. In particular, filling the stirring tank 1 with 4000 liters of water and adding 160 kg of fresh fiber and 4.8 liters of AKD achieves the desired properties of the packaging.

The pulp is fed through a pipe 3 to an immersion tank 4, in which a suction mold 5 is arranged so that it can be raised and lowered in the immersion tank 4. The suction mold 5 has a porous surface whose contour is complementary to the shape of the fiber molded body 6 to be produced. The suction mold 5 is connected to a suction device (e.g., a suction pump) which generates a vacuum on the porous surface of the suction mold 5, so that the water from the pulp in the immersion tank 4 is drawn through the porous surface of the suction mold 5 and the fibers from the pulp are deposited on the porous surface of the suction mold 5. The suction mold 5 is coupled to a lifting mechanism, which is represented by a lifting rod 7. In one embodiment, electric motor-driven or pneumatically operated drives for such lifting mechanisms are particularly well known.

The lifting mechanism can be used to lower the suction mold 5 into the suction position shown in FIG. 1 below the liquid level of the pulp and to raise it into a removal position above the liquid level of the pulp.

In the removal position, a transfer mold 8 can take the formed fiber molded body 6 from the suction mold 5 and transport it to a conveyor belt 9, where it is deposited. The transfer mold 8 may also have a porous surface connected to a suction device for suction of the fiber molded body 6 formed on the suction mold 5 and lifting it off the suction mold 5.

The conveyor belt 9 passes through a drying tunnel 10 which is heated so that the water contained in the fiber molded body 6 evaporates to a residual moisture content of approximately 20%.

The fiber molded body 6 is then placed in a press mold 11, where it is pressed with a pressure of approximately 60 t. For this purpose, a counter mold 12 is pressed against the fiber molded body 6 located on the press mold 11. The surfaces of the press mold 11 and the counter mold 12 are essentially complementary, so that the pressure is distributed evenly over the surface of the fiber molded body 6.

The resulting fiber molded body 6 has a firm surface that is resistant to water due to the AKD additive. At the same time, it is very stable and thermally insulating due to its large wall thickness of 3 mm to 6 mm. FIG. 1 also illustrates an optional coating station 13 in which the fiber molded body 6 is moved by means of a further conveyor belt 15 to spray nozzles 14, which can spray the upward-facing surface of the fiber molded body 6 with a biodegradable coating. The biodegradable coating can increase the strength of the fiber molded body 6 and the resistance to water.

In FIG. 1, the drawn fiber molded body 6 is schematically represented as five triangles arranged next to each other. This representation is only representative. The drawn fiber molded body can have any shape.

FIG. 2 illustrates two embodiments of the shell-shaped base bodies 16 and 16′. A large shell-shaped base body 16 and a small shell-shaped base body 16′ are shown. The size of the shell-shaped base body 16, 16′ must be selected depending on the size of the object to be packaged.

Each shell-shaped base body 16, 16′ has a bottom wall 17, 17′ and an adjoining side wall 18, 18′ extending upward. The shell-shaped base body 16, 16′ further includes a peripheral rim, comprised of two portions. The upper portion of the peripheral rim of the peripheral side wall 18, 18′ has a U-shaped cross-section, i.e., the upper end of the side wall 18, 18′ is joined by a circumferential portion 19, 19′ that runs essentially horizontally and parallel to the bottom wall 17, 17′, and a portion 20, 20′ that runs downwards again towards the bottom wall 17, 17′ is joined to this circumferential portion 19, 19′.

It can be seen that both the side walls 18, 18′ and the bottom walls 17, 17′ have rib-like bulges 21, 21′ and 22, 22′ that run in the longitudinal and transverse directions. Due to the rib-like bulges 21, 21′, 22, 22′, the base body 16, 16′ of the packaging described here is very stable.

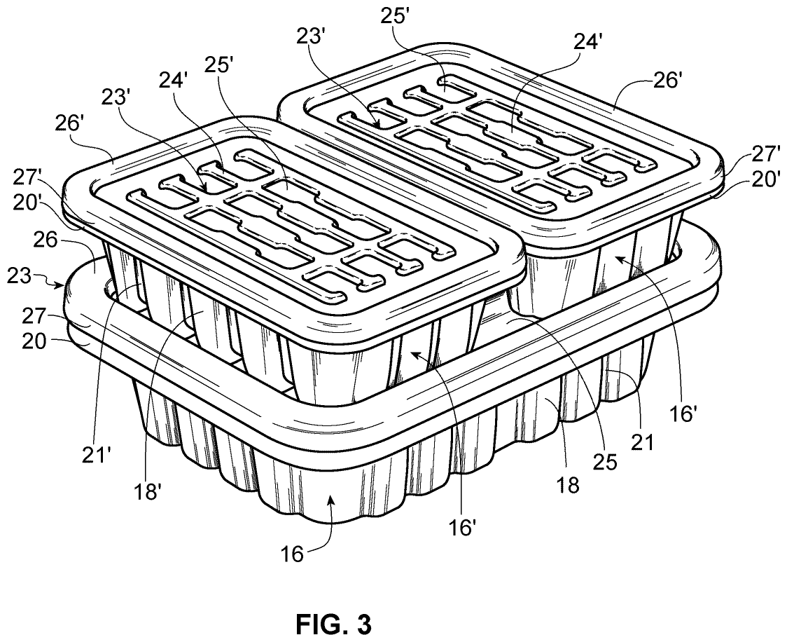

FIG. 3 shows a three-dimensional representation of stacked packaging containers. A packaging with a large base body 16 is covered with a large lid 23. Two packaging containers with a small base body 16′ are each covered with a small lid 23′. It can be seen that the lids 23, 23′ also have rib-like bulges 24′ that run lengthwise and crosswise across the top wall 25, 25′ of the lids 23, 23′. These rib-like bulges 24′ give the lids 23, 23′ great stability and enable the packaging to be stacked. The rib-like bulges 24′ of the top wall 25, 25′ of the lid 23, 23′ can also be arranged in relation to the rib-like bulges of the bottom wall in such a way that, when the bottom wall of a stacked container is placed on the top wall 25, 25′ of the lid 23, 23′, they interlock and secure the stack of stacked packaging containers against slipping.

In other words, the bottom wall of the base body 16 is shaped to complement the top wall 25 of the lid 23, so that the bottom wall engages positively with the top wall 25 of the lid 23 when two identical packaging containers are stacked. The bottom wall of the base body 16′ of a smaller packaging can be shaped to be complementary to one half of the top wall 25 of the lid 23 of the larger packaging, so that two of the smaller packaging containers can be placed side by side on the lid 23 of a large packaging in a substantially form-fitting manner, as shown in FIG. 3.

It can be seen that the lids 23, 23′ also have a U-shaped rim in cross-section, the lid rim, which runs essentially complementary to the peripheral rim of the covered base body 16, 16′. The rims of the lids 23, 23′ also have a first essentially horizontal portion 26, 26′ extending parallel to the bottom walls 17, 17′ that rests on the horizontal portion of the peripheral rim of the base body 16, 16′. This horizontal portion 26, 26′ forms the periphery of the top wall 25, 25′. A portion 27, 27′ of the lid rim extending downward towards the bottom wall adjoins the horizontal portion. This allows the shell-shaped base body 16, 16′ to be closed tightly by means of the corresponding lid 23, 23′. The portion 27, 27′ of the lid rim extending downwards towards the base wall ends above the portion 20, 20′ of the peripheral rim of the base body 16, 16′ pointing downwards towards the base wall. In this way, adhesive tape affixed to the portions of the lid rim and the portion of the peripheral rim extending downwards towards the bottom wall can be used to secure the lid 23, 23′ to the base body 16, 16′ and increase the tightness of the sealed packaging.

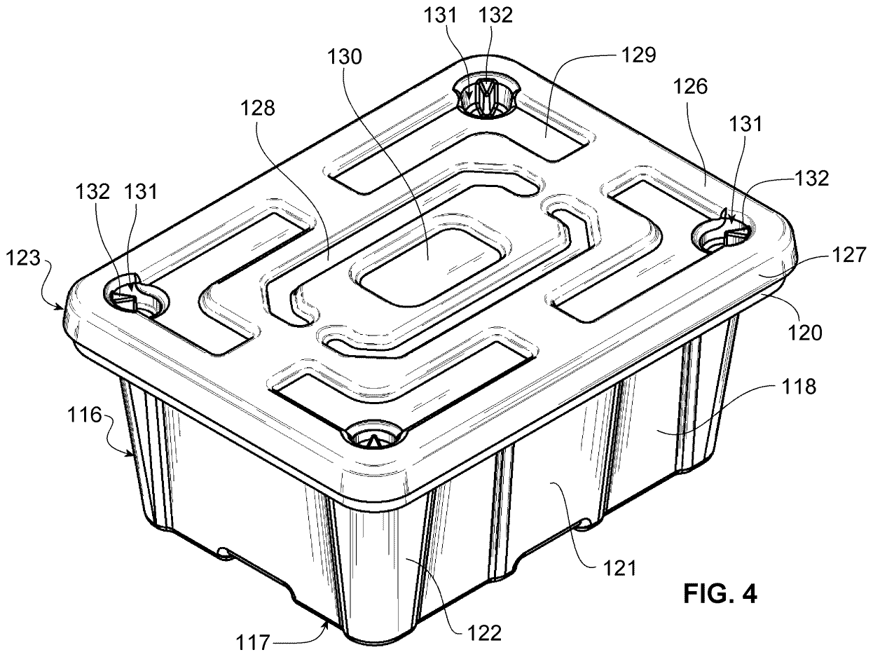

FIG. 4 shows a further embodiment of a packaging container consisting of a shell-shaped base body 116 with a lid 123. Again, the base body 116 has a circumferential U-shaped peripheral rim, of which the lower region of the portion 120 projecting towards the bottom wall 117 can be seen in FIG. 4. The side wall 118 of the base body 116 of the packaging container has large rib-like bulges 121 at the center of the longitudinal sides as well as large rib-like bulges 122 at the corner regions. The lid 123 has complex rib-like bulges formed by protruding areas of nested recesses 128, 129, 130, which stabilize the lid 123. The lid 123 additionally has recesses 131 in the corners of the lid 123, which further stabilizes the lid and facilitates the stacking of the lids 123 after production.

Retaining projections 132 protrude from the corners into the interior of the recesses 131, preventing the recesses 131 of the lid 123 from penetrating too deeply into each other when stacked.

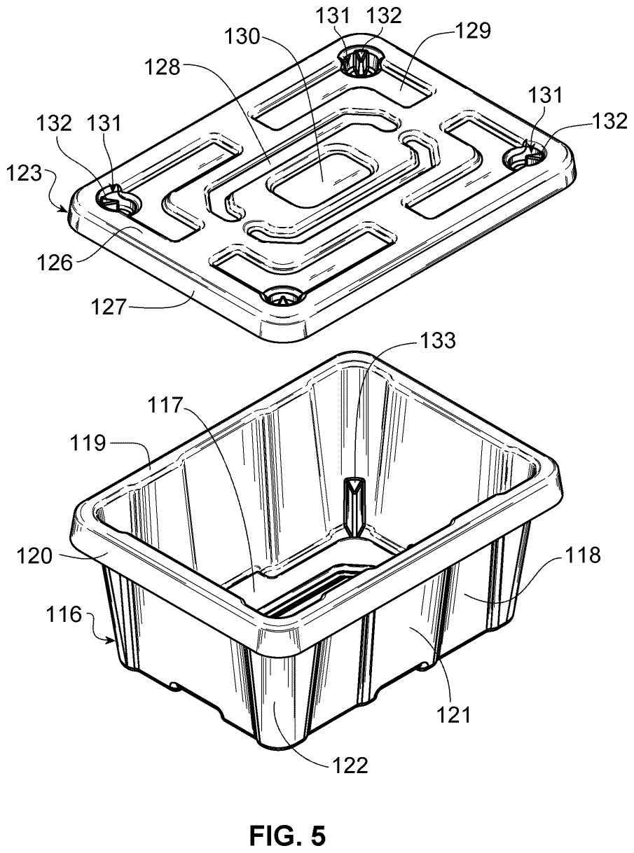

FIG. 5 shows a reduced-scale view of the packaging container shown in FIG. 4 with the lid 123 raised. The horizontal circumferential rim portion 119 of the peripheral rim of the base body 116, which adjoins the upper end of the side wall 118 of the base body 116, can be seen here. The lid 123 has a complementary peripheral horizontal lid rim portion 126 extending horizontally and a lid rim portion 127 projecting downwards towards the base wall 117. As in the embodiment described above, the portion 120 of the peripheral rim of the base body 116 extending toward the bottom wall 117 extends further down than the portion 127 of the lid rim extending downward parallel to it, so that the packaging container can be sealed tightly by simply applying adhesive tape onto the rim portions extending downward 127, 120 that are parallel to each other.

The side wall 118 of the base body 116 of the packaging container has large rib-like bulges 121 at the center of the longitudinal sides as well as large rib-like bulges 122 at the corner regions. These rib-like bulges 121, 122 are relatively flat and their extension transverse to the main plane of the wall of the base body 116 is less than 2 cm, preferably less than 1.5 cm, and thus approximately three to five times the thickness of the wall of the base body 116. This facilitates attaching labels to the side wall 118 of the base body 116. In addition, there are no pronounced corners or edges inside the base body 116 that could press into the goods contained in the packaging. However, there may be small retaining projections 133 inside the base body 116 near the bottom wall 117, which abut the bottom wall 117 of an identical base body 116 inserted in the base body 116 and which make the base bodies 116 stackable. In the embodiment of FIG. 5, the retaining projections 133 are located in the four corners of the base body 116. In other embodiments, the retaining projections may be arranged at different locations near the bottom wall. If a second identical base body 116 is inserted into a first base body 116, the insertion depth is limited by the retaining projections 133 and the two base bodies 116 can be easily separated from each other.

The lid 123 has complex rib-like bulges formed by protruding areas of nested recesses 128, 129, 130, which stabilize the lid 123. The nested recesses 128, 129, 130 are arranged symmetrically to the two center lines of the lid 123 in the longitudinal and transverse directions. The bottom wall 117 of the base body 116 has complementary projections that engage positively with the recesses 128, 129, 130. As in the embodiment described above, packaging containers with a half base area (not shown) can also be provided, the bottom walls of which engage positively with the recesses of one half of the lid 123.

The lid 123 additionally has recesses 131 in the corners of the lid 123, which further stabilize the lid and facilitate the stacking of the lids 123 after production. Retaining projections 132 protrude from the corners into the interior of the recesses 131, preventing the recesses 131 of the lid 123 from penetrating too deeply into each other when stacked. This allows the lid 123 to be stacked after production and later separated from each other easily and without effort.

The features of the invention disclosed in the present description, drawings, and claims may be essential for the realization of the invention in its various embodiments, either individually or in any combination. In particular, the described geometric features of the packaging are also advantageous for fiber packaging whose fiber mixture does not contain any AKD. The geometric features of the packaging are also advantageous if the fiber material is not drawn from a pulp. For example, compression molding processes are known for producing thin-walled fiber molded bodies, in which a viscous fiber pulp slurry is introduced into a first mold and a second, complementary mold is pressed in, so that a thin gap is created between the two molds in which the fiber material is accommodated. In the process, most of the water is pressed out of the fiber pulp. The invention is not limited to the embodiments described. It can be varied within the scope of the claims and taking into account the knowledge of the skilled person.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

1. A packaging container made of biodegradable fiber material, comprising:
a shell-shaped base body with a bottom wall, a surrounding side wall, and a peripheral rim; and
a lid with a top wall and a lid rim that extends complementary to the peripheral rim of the shell-shaped base body;
wherein the shell-shaped base body and the lid are produced by means of a mold from a pulp containing a mixture of water and fresh fiber;
wherein alkyl ketene dimers are added to the pulp as an additive;
wherein the shell-shaped base body and the lid are dried and pressed after drying; and
wherein the shell-shaped base body and the lid have a wall thickness of at least 3 mm.

2. The packaging container of claim 1, wherein the peripheral rim has a portion extending outward parallel to the bottom wall and an adjoining portion extending downward toward the bottom wall, wherein the lid rim has an outwardly extending portion and an adjoining portion extending downward toward the bottom wall.

3. The packaging container of claim 2, wherein the top wall of the lid is connected to the outwardly extending portion of the lid rim via an upwardly extending junction section.

4. The packaging container of claim 2, wherein the adjoining portion of the lid rim extending downward toward the bottom wall ends above the adjoining portion of the peripheral rim extending downward toward the bottom wall.

5. The packaging container of claim 2, wherein the adjoining portion of the lid rim extending downwards toward the bottom wall has at least one recess.

6. The packaging container of claim 1, wherein the surrounding side wall of the shell-shaped base body includes several rib-like bulges.

7. The packaging container of claim 6, wherein the rib-like bulges extend transverse to the surrounding side wall of the shell-shaped base body, wherein the extension of the rib-like bulges is equal to or less than five times the surrounding wall thickness.

8. The packaging container of claim 1, wherein the lid includes four corners, wherein each corner of the four corners includes a recess.

9. The packaging container of claim 8, wherein each recess includes a retaining projection which protrudes from one side of the recess towards a center of the recess.

10. The packaging container of claim 1, further comprising a biodegradable or bioinert coating applied to an inside of the shell-shaped base body and/or to a side of the lid facing the shell-shaped base body.

11. A packaging container made of biodegradable fiber material, comprising:
a shell-shaped base body with a bottom wall, a surrounding side wall, and a peripheral rim; and
a lid with a top wall and a lid rim that extends complementary to the peripheral rim of the shell-shaped base body;
wherein the biodegradable fiber material contains hemp fibers.

12. The packaging container of claim 11, wherein the biodegradable fiber material contains a mixture of hemp fibers and ground hemp shives.

13. The packaging container of claim 11, wherein the surrounding side wall of the shell-shaped base body includes several rib-like bulges.

14. The packaging container of claim 11, wherein the lid includes four corners, wherein each corner of the four corners includes a recess, wherein each recess includes a retaining projection which protrudes from one side of the recess towards a center of the recess.

15. The packaging container of claim 11, further comprising a biodegradable or bioinert coating applied to an inside of the shell-shaped base body and/or to a side of the lid facing the shell-shaped base body.

16. A packaging container made of biodegradable fiber material, comprising:
a shell-shaped base body with a bottom wall, a surrounding side wall, and a peripheral rim; and
a lid with a top wall and a lid rim that extends complementary to the peripheral rim of the shell-shaped base body;
wherein the peripheral rim has a portion that extends downward beyond the lid rim.

17. The packaging container of claim 16, wherein the shell-shaped base body and the lid have a wall thickness of at least 3 mm.

18. The packaging container of claim 16, wherein the surrounding side wall of the shell-shaped base body includes several rib-like bulges.

19. The packaging container of claim 16, wherein the lid includes four corners, wherein each corner of the four corners includes a recess, wherein each recess includes a retaining projection which protrudes from one side of the recess towards a center of the recess.

20. The packaging container of claim 16, further comprising a biodegradable or bioinert coating applied to an inside of the shell-shaped base body and/or to a side of the lid facing the base body.
